(19) United States
(12) Patent Application Publication
(10) Pub. No.: US 2009/0177763 A1
(43) Pub. Date: Jul. 9, 2009

(54) DATA RESTORE DEVICE AND SYSTEM AND METHOD FOR RESTORING CONFIGURATION DATA

(75) Inventor: Yang Lu, Shijr City (TW)

Correspondence Address: KIRTON AND MCCONKIE, 60 EAST SOUTH TEMPLE,, SUITE 1800, SALT LAKE CITY, UT, 84111, US

(73) Assignee: ATEN INTERNATIONAL CO., LTD., Shijr City (TW)

(21) Appl. No.: 11/969,523

(22) Filed: Jan. 4, 2008

(51) Int. Cl. G06F 15/177

(52) U.S. Cl. 709/221

(57) ABSTRACT

The invention provides a convenient and rapid concurrent manner to restore a group of target devices. Restore configuration data from a source device is transferred to the group of target devices by a data restore device over a network. The data restore device instructs each target device to partially cover original configuration data with the restore configuration data so as to restore the target devices. By using the present invention, it takes only a very short period of time to restore the target devices in one group even the number of target devices in this group is great.

### TECHNICAL FIELD OF THE INVENTION

The present invention relates to data restore, more particularly, to a system and method for restoring a plurality of target devices as well as a data restore device used therein.

### BACKGROUND OF THE INVENTION

In current computer management, it is convenient to use a data management device with multiple ports for connecting with a plurality of terminals. The data management device collects data from the terminals and transfers the data over a network to a remote console, so that a user at the end of the console can monitor the conditions of the terminals.

Sometimes it is necessary to restore a new data management device according to configuration data of an existing data management device. If there are a number of data management devices (e.g. 50 data management devices) are to be restored in the same style, that is, to be restored by using the same configuration data, it will be very verbose and redundant to restore the respective data management devices separately and individually.

### SUMMARY OF THE INVENTION

The present invention is to provide a rapid and efficient solution to restore a group of target devices such as data management devices by using the same configuration data.

In accordance with an aspect of the present invention, a system for restoring configuration data comprises a group of target devices, each of which has original configuration data thereof; a source device transferring restore configuration data via a network; and a data restore device. The data restore device is connected to the source device and the group of target devices via the network, respectively. The data restore device has a storage and a utility storing the restore configuration data of the source device transferred via the network from the source device to the storage, transferring the restore configuration data of the source device from the storage to the respective target devices of the group and instructing each target device of the group to cover the original configuration data thereof with the restore configuration data of the source device.

In accordance with another aspect of the present invention, a method for restoring configuration data comprises steps of transferring restore configuration data of a source device via a network; storing the restore configuration data of the source device; and transferring the stored restore configuration data of the source device to a group of target devices having original configuration data thereof, respectively; and covering the original configuration data of each target device with the restore configuration data of the source device.

The configuration data includes a replaceable portion and a non-replaceable portion. The utility instructs the target device to use the replaceable portion of the restore configuration data of the source device to cover the corresponding portion of the original configuration data, and maintains the non-replaceable portion of the original configuration data. The non-replaceable portion of the original configuration data of each device mainly comprises identification data of the device.

### BRIEF DESCRIPTION OF THE DRAWINGS

FIG. 1 is a schematic illustration showing a system for restoring configuration data in accordance with the present invention; and

FIG. 2 is a flow chart showing a method for restoring configuration data in accordance with the present invention.

### DETAILED DESCRIPTION OF THE INVENTION

The present invention will be described in detail in conjunction with the appending drawings.

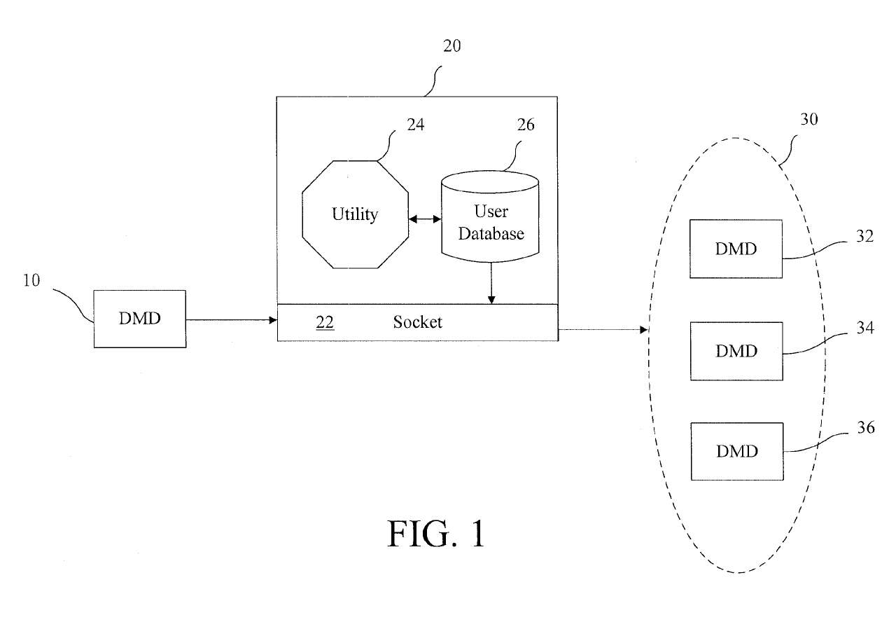

FIG. 1 is a schematic illustration showing a system for restoring configuration data in accordance with the present invention. As shown in this drawing, a source data management device (DMD) 10 is connected to of a data restore device 20 via a network (not shown) such as Internet, Ethernet, Intranet, Local area network, Wide area network, or wireless network. The data restore device 20 can be implemented by a person computer, for example. The data restore device 20 is connected with the source data management device 10 through a socket 22. A utility 24 built in the data restore device 20 stores configuration data of the data management device 10 into a storage such as a database 26 for backup. The configuration data contains various data for describing functions, characteristics, connections and the like of the data management device 10, such as IP address of the data management device, serial port baud rat, ModBus settings, IP address of SNMP (Simple Network Management Protocol) mangers and so on.

The data restore device 20 can be incorporated in a console for administrating a great number of data management devices. The data management devices are grouped into plural groups in advance. The respective data management devices in the same group have similar configuration data and are connected to the data restore device 20 via the network (not shown) such as Internet, Ethernet, Intranet, Local area network, Wide area network, or wireless network.

If a user intends to restore all data management devices 32, 34, 36 of a group 30 by using the configuration data of the data management device 10, the user selects group 30 through the utility 24 of the data restore device 20 via a GUI (Graph User Interface) tool and instructs the data restore device 20 to transfer the configuration data of the data management device 10 to the data management devices 32, 34, 36 simultaneously, so as to restore the data management devices 32, 34, 36 at the same time. Herein, the data management device 10 providing the configuration data is referred to as a “source device”, while each of the data management devices 32, 34, 36 receiving the configuration data is referred to as a “target device”. In addition to the data management device, other devices with configuration data may also be the source device(s) and/or target devices. It is also possible to select a portion rather than all of devices of one group as the target devices to be restored by using the configuration data of the source device.

As can be known, each of the target data management devices 32, 34, 36 has its own original configuration data. To restore the target data management device, the original configuration data of the target data management device is covered with the configuration data of the source data management device 10. The latter configuration data can be referred as “restore configuration data” for the sake of descriptive convenience. In one embodiment, the GUI tool may include backup configuration, restore configuration and restoring process. The GUI tool may guide a user how to login in/out and backup configuration data from which data management device in the network. The GUI tool may guide a user how to login in/out and restore stored configuration data to which group of data management devices in the network.

The configuration data of each data management device are classified into replaceable portion and non-replaceable portion. When the target data management device 32, for example, receives the restore configuration data of the source data management device 10 and a restore command from the utility 24, the replaceable portion of the original configuration data of the target data management device 32 is replaced with the corresponding portion of the restore configuration data of the source data management device 10, while the non-replaceable portion of the original configuration data of the target data management device 32 remains unchanged. The non-replaceable portion of the configuration data mainly includes identification information of the data management device, such as IP address, physical address (e.g. MAC address), sub-net mask, gateway address, DHCP (Dynamic Host Configuration Protocol) flag, name of the device, group name, description information and the like. Other information of the configuration data can be classified into replaceable portion, such as radius server setting, network settings (not including IP, MAC, Sub-net Mask, Gateway and DHCP flag), settings for PPP (Point-to-Point Protocol), event notification for alert string (e.g. email setting), time value, port configuration (e.g. work mode, baud rate, stop bits, etc.), user login information (e.g. username, password and rights), session time, log counter, alert string values, SNMP settings (IP of SNMP manager, community name), access IP address (i.e. IP addresses of hosts having access right), LDAP (Light Directory Access Protocol) settings, virtual modem settings, consol port flag and the like.

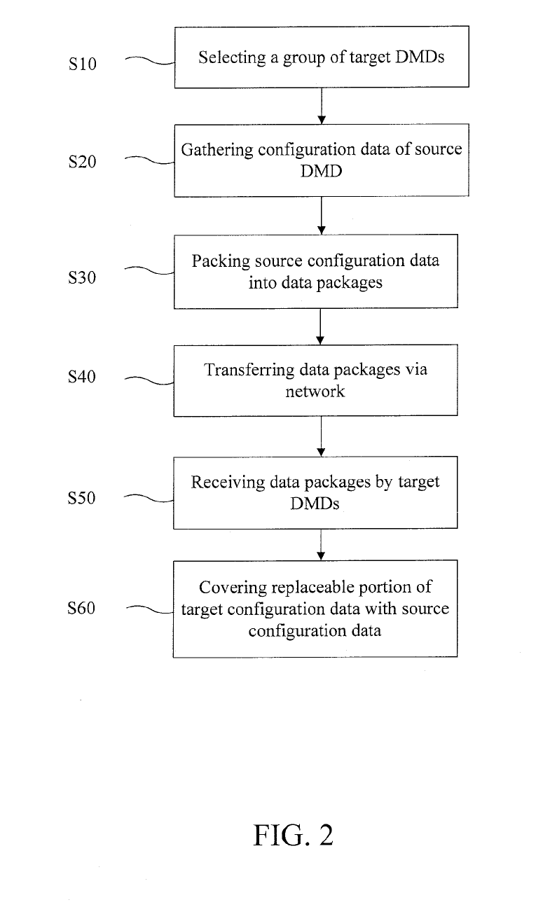

The process of the system in accordance with the present invention will be clearly and definitely described in details with reference to FIG. 2. FIG. 2 is a flow chart showing a method for restoring configuration data in accordance with the present invention. The restore configuration data of the source data management device 10 is transferred to the data restore device 20 for backup in advance. The data restore device 20 stores the configuration data in the database 26. This backup process can be done at any time before the restore process begins. In the beginning of the restore method of the present invention, the data restore device 20 selects a group of target data management devices in step S10. In this example, the data restore device 20 selects group 30, and all data management devices 32, 34, 36 in the group 30 are selected to be restored. However, it is also possible that only a portion of the target devices in the selected group are chosen to be restored. The utility 24 of the data restore device 20 gathers restore configuration data of the source data management device 10 from the database 26 in step S20. The data restore device 20 packs the restore configuration data into data packets which can be transferred over the network in step S30. In step S40, the data restore device 20 then transfers the data packets one by one to the target data management devices 32, 34, 36 of the selected group 30 via the network according to socket UDP communication based on TCP/IP at the same time. In step S50, the target data management devices 32, 34, 36 receive the data packets containing the restore configuration data and save the same, respectively. Then, the utility 24 transmits the restore command to the respective data management devices 32, 34, 36 so that the respective data management devices 32, 34, 36 cover the replaceable portion of the original configuration data of their own with the corresponding portion of the restore configuration data, while keep the non-replaceable portion thereof unchanged in step S60 according to the restore command.

In one embodiment, there are 50 targets in a private network, if a user wants to configure these target data management devices in the same style. For example, the user wants to set the all the port's baud rate at 115200 and subnet mask at 255.255.255.0 at the same time, the only thing the user should do is to backup one copy of configuration data from a data management device of which baud rate is at 115200 and subnet mask is at 255.255.255.0 and then restore the data into all other targets at same time by the utility in the data restore device. When backup data, the utility in the data restore device 20 sends command to a target data management device. The target data management device gathers all configuration data and packs the data into a data area. The utility in the data restore device 20 gets the data area by some protocol and save the configuration data to a local binary file. So the user gets a binary file after the backup, and this file will be used when restoring configuration data to other target data management devices.

By using the system and method of the present invention, group restore for multiple target devices is achieved. The invention provides a convenient and rapid concurrent manner to restore a number of target devices with the same configuration data. It takes only less than one minute to restore all the target devices in one group even the number of target devices in this group is great.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A system for restoring configuration data, the system comprising:
a group of target devices, each of which has original configuration data thereof;
a source device transferring restore configuration data via a network; and
a data restore device connected to the source device and the group of target devices via the network, respectively, the data restore device comprising:
a storage; and
a utility storing the restore configuration data of the source device transferred via the network from the source device to the storage, transferring the restore configuration data of the source device from the storage to selected target devices of the group and instructing each selected target device of the group to cover the original configuration data thereof with the restore configuration data of the source device.

2. The system as claimed in claim 1, wherein the utility partially covers the original configuration data of each target device with the restore configuration data of the source device.

3. The system as claimed in claim 2, wherein the configuration data includes a replaceable portion and a non-replaceable portion, the utility instructs the target device to use the replaceable portion of the restore configuration data of the source device to cover the corresponding portion of the original configuration data, and maintains the non-replaceable portion of the original configuration data.

4. The system as claimed in claim 3, wherein the non-replaceable portion of the original configuration data comprises identification information.

5. The system as claimed in claim 4, wherein the non-replaceable portion comprises at least one selected from a group consisting of IP (Internet Protocol) address, physical address, sub-net mask, gateway address, DHCP (Dynamic Host Configuration Protocol) flag, device name, group name, and device description.

6. The system as claimed in claim 1, wherein the group of target devices are selected through the utility by a user.

7. The system as claimed in claim 1, wherein the utility transfers the restore configuration data to the respective target devices of the group at the same time.

8. A data restore device connected to a source device and a group of target devices via a network, respectively, each target device having original configuration data; the source device having restore configuration data, the data restore device comprising:
a storage; and
a utility storing the restore configuration data of the source device transferred via the network from the source device to the storage, transferring the restore configuration data of the source device from the storage to selected target devices of the group and instructing each selected target device of the group to cover the original configuration data thereof with the restore configuration data of the source device.

9. The data restore device as claimed in claim 8, wherein the utility partially covers the original configuration data of each target device with the restore configuration data of the source device.

10. The data restore device as claimed in claim 9, wherein the configuration data includes a replaceable portion and a non-replaceable portion, the utility instructs the target device to use the replaceable portion of the restore configuration data of the source device to cover the corresponding portion of the original configuration data, and maintains the non-replaceable portion of the original configuration data.

11. The data restore device as claimed in claim 10, wherein the non-replaceable portion of the original configuration data comprises identification information.

12. The data restore device as claimed in claim 11, wherein the non-replaceable portion comprises at least one selected from a group consisting of IP (Internet Protocol) address, physical address, sub-net mask, gateway address, DHCP (Dynamic Host Configuration Protocol) flag, device name, group name, and device description.

13. The data restore device as claimed in claim 8, wherein the group of target devices are selected through the utility by a user.

14. The data restore device as claimed in claim 8, wherein the utility transfers the restore configuration data to the respective target devices of the group at the same time.

15. A method for restoring configuration data, the method comprising steps of:
transferring restore configuration data of a source device via a network;
storing the restore configuration data of the source device;
transferring the stored restore configuration data of the source device to a group of selected target devices, each of which has original configuration data thereof; and
covering the original configuration data of each selected target device with the restore configuration data of the source device.

16. The method as claimed in claim 15, wherein the original configuration data of each target device is partially covered with the restore configuration data of the source device.

17. The method as claimed in claim 16, wherein the configuration data includes a replaceable portion and a non-replaceable portion, the replaceable portion of the restore configuration data of the source device is used to cover the corresponding portion of original configuration data of each target device, while the non-replaceable portion of the original configuration data of each target device remains.

18. The method as claimed in claim 17, wherein the non-replaceable portion of the configuration data comprises at least one selected from a group consisting of IP address of the device, physical address of the device, sub-net mask of the device, gateway address of the device, DHCP (Dynamic Host Configuration Protocol) flag of the device, device name, group name, and device description.

19. The method as claimed in claim 15, further comprising selecting the respective targets device of the group from a multiple of target devices.

20. The method as claimed in claim 15, wherein the restore configuration data of the source device are transferred to the respective target devices of the group at the same time.
